(19) United States
(12) Patent Application Publication
(10) Pub. No.: US 2025/0259427 A1
(43) Pub. Date: Aug. 14, 2025

(54) EVALUATING RESULTS OF A COMPUTER-BASED MACHINE LEARNING SYSTEM

(71) Applicant: Robert Bosch GmbH, Stuttgart (DE)

(72) Inventors: Roman Gansch, Renningen (DE); Andreas Heyl, Weil Der Stadt (DE)

(21) Appl. No.: 19/047,159

(22) Filed: Feb. 6, 2025

(30) Foreign Application Priority Data
Feb. 9, 2024 (DE) 10 2024 201 218.1

(51) Int. Cl. G06V 10/776; G06V 10/75; G06V 10/764

(52) U.S. Cl. CPC G06V 10/776; G06V 10/751; G06V 10/764

(57) ABSTRACT

A computer-implemented method for evaluating results of a computer-based machine learning system. The method includes receiving a data set of real elements, wherein each real element of the data set of real elements corresponds to a real observation; receiving a first result that was calculated by the computer-based machine learning system using the data set of real elements; generating a data set of synthetic elements in relation to the data set of real elements; transmitting the data set of synthetic elements; receiving a second result calculated by the computer-based machine learning system using the data set of synthetic elements; comparing the first result to the second result; determining, based on the first result and/or comparing the first result to the second result, one or more validity values characterizing a confidence measure of the calculated first result.

### FIELD

The present invention relates to techniques for evaluating results of a computer-based machine learning system. Related aspects concern a computer program, a monitoring module, a device, and a distributed system.

### BACKGROUND INFORMATION

Computer-based machine learning systems are increasingly being used in various technical devices. In many cases, computer-based machine learning systems (e.g., those that use artificial neural networks) must be extensively trained and/or validated based on known data sets in order to provide plausible output data (i.e., unknown output data) for any given input data of a device. However, the use of such models in safety-critical applications (e.g., in connection with autonomous or assisted driving) is limited, because if the machine learning system operates on different data sets than those on which it was trained and/or validated, some of the related art methods can supply unexpected results (e.g., false positive and/or false negative results). In some cases, e.g. in image processing, an artificial neural network can misclassify an object in an image that was originally correctly classified, if the same image is filled with noise (even if such noise would not be recognizable to the human eye).

Therefore, some existing computer-based machine learning systems of the related art generate uncertainty values (directly or using a separate probabilistic model) together with the output data, which quantify the extent to which the calculated output data are reliable. However, these uncertainty values, provided by computer-based (e.g., in-vehicle) machine learning systems of the related art that can be generated in real time in a moving vehicle, do not relate to a current environment/scene and, what may be even more problematic, to its temporal evolution. In addition, some methods of the related art do not take into account how uncertainty values change over time. This may lead to an overestimation of the reliability of the results generated by the computer-based machine learning systems, which may be unacceptable for safety-critical applications.

Therefore, there is a need to develop new technologies for computer-based machine learning systems that can solve some or all of the aforementioned problems.

### SUMMARY

A first general aspect of the present invention relates to a computer-implemented method for evaluating results of a computer-based machine learning system. According to an example embodiment of the present invention, the method comprises receiving a data set of real elements, wherein each real element of the data set of real elements corresponds to a real observation. The method further comprises receiving a first result that was calculated by the computer-based machine learning system using the data set of real elements. In the next step, the method of the first aspect comprises generating a data set of synthetic elements in relation to the data set of real elements. Furthermore, the method comprises transmitting the data set of synthetic elements. The method further comprises receiving a second result calculated by the computer-based machine learning system using the data set of synthetic elements. To this end, the method of the first aspect comprises comparing the first result to the second result. Finally, the method comprises determining, based on the first result and/or comparing the first result to the second result, one or more validity values characterizing a confidence measure of the calculated first result.

A second general aspect of the present invention relates to a computer program that is designed to execute the method according to the first general aspect of the present invention.

A third general aspect of the present invention relates to a monitoring module designed to execute the computer-implemented method according to the first general aspect of the present invention and/or to execute the computer program according to the second general aspect of the present invention.

A fourth general aspect of the present invention relates to a device comprising a monitoring module according to the third aspect of the present invention. Furthermore, the device comprises a module comprising a computer-based machine learning system, wherein the module is designed to receive a data set of real elements received from the monitoring module of the third aspect. In addition, the module is designed to calculate the first result by the computer-based machine learning system using the data set of real elements and to transmit the first result to the monitoring module.

A fifth general aspect of the present invention relates to a distributed system comprising a device according to the fourth aspect and an additional module comprising a computer-based machine learning system. The additional module is designed to receive a data set of synthetic elements transmitted from the monitoring module according to the third aspect of the present invention. Furthermore, the additional module is designed to generate a second result by the computer-based machine learning system using the data set of synthetic elements and to transmit the second result to the monitoring module.

The techniques of the first to sixth general aspects of the present invention can have one or more of the following advantages.

First, the present techniques can allow efficient determination of a confidence measure for the results generated by a computer-based machine learning system in real time in relation to real-world elements associated with real-world observations (e.g., if these real elements, such as captured image data, are processed in real time by the computer-based machine learning system). In particular, based on these generated results, which in some cases comprise uncertainty values together with the output data of the computer-based machine learning system, it can be concluded in real time whether the output data are trustworthy enough (or not) for a particular application.

Second, the present techniques offer the possibility to generate synthetic elements for the real elements analyzed at a current point in time, which can emulate the temporal evolution of the current scene/environment (including, e.g., the synthetic elements emulating future, not yet captured real elements), and which are also processed by the computer-based machine learning system. It is possible to compare the results generated by the computer-based machine learning system in connection with the synthetic and real elements in order to further specify a confidence measure of the results generated in relation to the real-world elements (e.g., in real time). As a result, it is possible to use the present techniques to assess the extent to which the results generated in relation to the real elements are trustworthy using relatively limited hardware resources and more accurately than some techniques of the related art.

Some terms are used in the present disclosure in the following way:

The term “computer-based machine learning system” in the present disclosure means any device that can be or has been trained for one or more tasks with the aid of machine learning. During training, training data sets can be provided as input data to the computer-based machine learning system, and the properties (e.g., corresponding parameters) of the computer-based machine learning system can be adapted in response to the processing of the training data sets (e.g., by analyzing the output data) in order to solve the one or more tasks in a defined manner (e.g., with a certain accuracy). A computer-based machine learning system can contain a model that can be parameterized. Adapting the properties of the machine learning system during learning can be done, e.g., by means of an optimization method in relation to (unknown) parameters of the machine learning system (e. g., a corresponding model), which can be represented as minimization of a loss function (within the framework of a predetermined numerical accuracy and/or until a predetermined termination criterion is reached). The adapted computer-based machine learning system can then be used to predict the responses for the observations in another data set, called the validation data set: Thus, the validation data set can provide an evaluation of the fit of the machine learning system to the training data sets. Finally, in some cases, test data sets can be used, which are typically used for evaluating the final machine learning system selected during the validation process.

In some cases, “a computer-based machine learning system” can perform a classification task or a regression task. As a non-limiting example, the computer-based machine learning system (e.g., its model) can comprise an artificial neural network having a particular topology and a number of neurons with corresponding connections. According to some embodiments, the neural network can be a convolutional neural network (CNN for short) that is defined, for example, by the number of filters, filter sizes, step sizes, etc. A convolutional neural network can, for example, be used for the purpose of image classification and perform one or more transformations on digital images based on, for example, convolution, nonlinearity (ReLU), pooling or classification operations (e.g. using fully connected layers). The neural network can also be designed as a multilayer feedforward or recurrent network, as a neural network with direct or indirect feedback, or as a multilayer perceptron. The machine learning systems based on neural networks can be used in a vehicle computer or another vehicle component or in an at least partially autonomous robot (e.g., for evaluating an operating state of the vehicle or robot and/or for controlling a function of the vehicle or robot based on state and/or environmental data of the vehicle or robot as input data). For example, computer-based machine learning systems can be implemented in any suitable form, i.e., in software, in dedicated hardware, or in a hybrid of software and dedicated hardware. Therefore, the computer-based machine learning systems can be a software module (also integrated into a higher-level software system) that can run on a general-purpose processor. In other cases, a computer-based machine learning system can be (at least in part) implemented in circuitry.

Within the scope of this disclosure, the term “data set of real elements” may refer to a collection of real elements (or, in some cases, one real element) associated with real observations (in other words, real-world observations, e.g., measurements). Depending on the nature of the task for which a computer-based machine learning system is used, the elements of a “data set of real elements” can contain different information. For example, each real element of a “data set of real elements” can contain a single image (or a section thereof). For example, an image element can contain a number of image pixels (e.g. 1024×2048 pixels), wherein each image pixel has a number of color values (e.g. three color values with 16 bit color depth). In other examples, elements of a “data set of real elements” can contain data series (e.g., time series). The image data and/or data series can be generated by means of various sensors (e.g., cameras, radar, lidar, ultrasonic, GPS or thermal sensors, sensors for controlling the engine of a vehicle). In some examples, a sensor of a vehicle can be used, for example, within the framework of semi-autonomous, autonomous or assisted driving of a vehicle, in order to provide a functionality for the vehicle (for example, in relation to safety functions, the realization of driver information and comfort functions, such as intelligent headlight control and traffic sign information).

A “feature” of an element of a “data set of real elements” in the present disclosure may refer to a part of the element that is recognizable in this element (e.g., by corresponding data processing) and that can be characterized by a specific property or assigned to certain categories (e.g., by means of an image classifier as a computer-based machine learning system). If an element is an image, a feature may refer to a spatially limited part of a scene represented in an image and/or a plurality of pixels corresponding to a corresponding part of an image. In the example of a vehicle-integrated sensor system, a “feature” can be an object in the images in connection with street scenes recorded (in other words: captured) thereof (e.g., in real time while a vehicle is driving). A non-exhaustive list of such objects (i.e., features) can comprise traffic signs, lanes or other road or pedestrian markings, trees, buildings, road users such as pedestrians, cyclists or other vehicles. Within the scope of the present disclosure, it is also possible that a “feature” can be a part of an object: In some cases, where a vehicle is recognized in an image, a “vehicle color” and a “vehicle tire” are examples of such features. In addition, “features,” such as “weather” or “time of day,” can also be extracted from an image. An “element” that contains a (measured) data series (e.g., time series) from a sensor can also contain corresponding “features.” For example, a steering wheel angle while driving as a function of time or injection times in the engine of a vehicle over the pressure curve are two non-exhaustive examples of such features. In some cases, features can be extracted (e.g., calculated) from the element's data series: For example, the minimum and/or maximum of a time series or the maximum and/or minimum derivative (i.e., the slope) of a time series or any combination thereof can be calculated and assigned to a corresponding feature.

Accordingly, the term “synthetic element data set” may refer to a collection of synthetic elements (or, in some cases, one synthetic element) that, unlike the elements of a “data set of real elements,” are not linked to real observations, but instead have an artificial origin. For example, a “synthetic element” is not a recorded image and therefore does not require any data processing, such as image processing. A synthetic element can be generated from one or more real elements (e.g., recorded images) which are varied (in other words: distorted) according to their nature, in order to generate this synthetic element. The synthetic element can resemble the original real elements (or the real element) from which it was generated following the variation thereof, in the sense that it also contains one or more “features” present on those original real elements (or the real element). In the example of recorded images (e.g., by a camera), this variation can comprise one or more variations from the following non-exhaustive list: i) pixel-level variation for modeling sensor noise; ii) optical-flow-based variation for modeling object motion at pixel level; iii) variation based on motion models of the objects; iv) variation by means of synthetically rendered images or other variations.

Within the scope of the present disclosure, it is possible that a “real” or “a synthetic element” is fed as input data into a computer-based machine learning system that can provide a corresponding “result.” This “result” can be a processing result for this element by the machine learning system that is generated by the machine learning system in the form of output data. In addition, the “result” can comprise an “uncertainty value” in relation to the generated output data, which value can quantify the extent to which those output data are trustworthy (more on this below). As mentioned above, a “computer-based machine learning system” can be a classifier that can be designed to receive “elements” as input data and classify “features” of those elements into corresponding classes. In some cases, a classifier can provide probabilities with which a feature was classified into different classes (e.g., after recognition of these features on the elements). In some examples, a classifier can be an image classifier, which semantically segments image data pixel-by-pixel or region-by-region. The image classifier can be designed to receive input data (e.g., an “element”) in the form of image data and classify it into multiple classes. In some examples, this can comprise mapping input data in the form of an input vector of one dimension (Rⁿ), which vector contains image data, onto output data in the form of an output vector of a second dimension (R^{m}), which represents a classification result. For example, components of the input vector can represent image data associated with an image. Each component of the output vector can represent an image classification result, which can be calculated based on the computer-based machine learning system of the present disclosure.

The term “vehicle” comprises any apparatus designed for the transportation of passengers and/or cargo. The vehicle can be a motor vehicle (for example, an at least partially autonomously operating/assisted motor vehicle, in particular a car or a truck). However, the vehicle can also be a ship, a train, an aircraft or a spacecraft. Other devices are also possible within the scope of the present disclosure, more on this below.

### BRIEF DESCRIPTION OF THE DRAWINGS

FIG. 1A is a flow chart showing an example of a method for evaluating results of a computer-based machine learning system according to the first aspect of the present invention.

FIG. 1B and 1C are flow charts showing the further possible method steps according to the first aspect of the present invention.

FIG. 2A and 2B show schematic examples of real elements 1; 2 from the data set of real elements, which represent two captured images at different points in time, on which six features, namely “vehicles 10, 14,” “pedestrians 11, 13,” and a “cyclist 15,” can be seen. These figures also show examples if parts of these images (regions in dashed circles) are considered as real elements 1a; 2a with a feature, the “vehicle 10.”

FIG. 3 schematically shows an exemplary monitoring module 20 according to the present invention that communicates with the following modules: i) a module 30 that comprises a computer-based machine learning system 70; ii) an additional module 40 that comprises the same computer-based machine learning system 70; and iii) a planner 50. The incoming and outgoing arrows illustrate an example of communication between the modules. 60: a data set of real elements; 61/62: output data/uncertainty values for real elements (“first result”); 63: generated data set of synthetic elements; 64/65: output data/uncertainty values for synthetic elements (“second result”).

### DETAILED DESCRIPTION OF EXAMPLE EMBODIMENTS

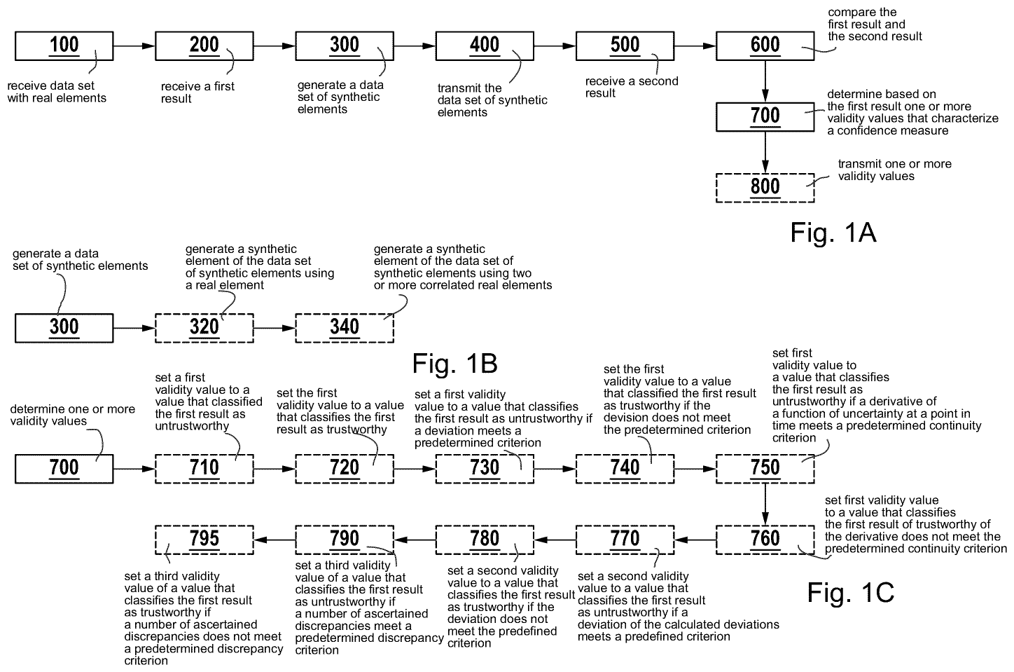

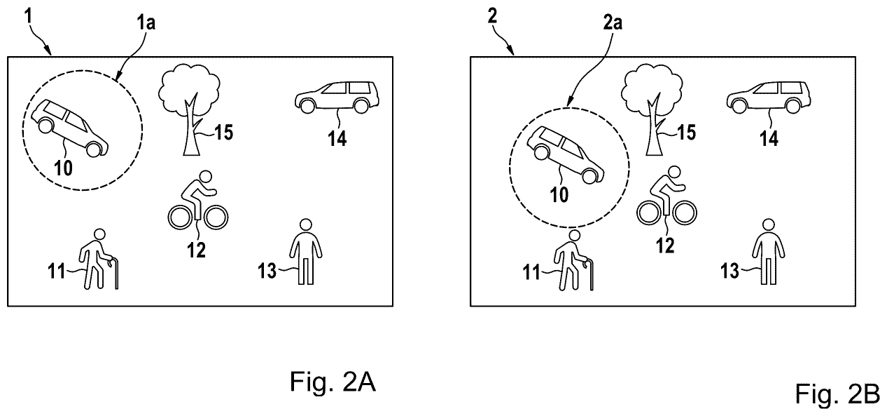

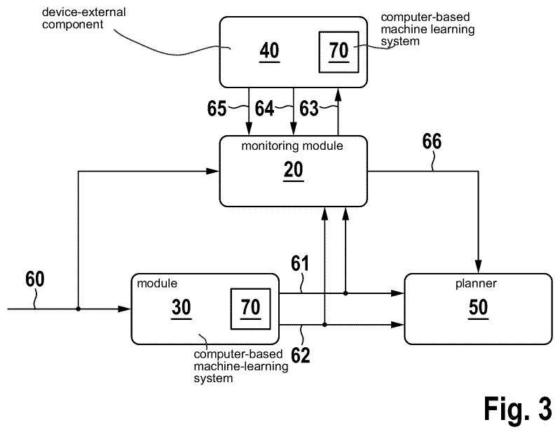

First, techniques of the present invention for evaluating results of a computer-based machine learning system are described in reference to FIG. 1A to 1C. Then, exemplary “real elements” of the present techniques with their “features” present therein are discussed in reference to FIG. 2A and 2B. Finally, an exemplary monitoring module 20 for an implementation of the computer-implemented method of the first aspect is described in reference to FIG. 3.

As diagrammed in the FIG. 1A to 1C, a first general aspect of the present invention concerns a computer-implemented method for evaluating results of a computer-based machine learning system. As described above, a computer-based machine learning system can, for example, comprise an artificial neural network (e.g., a CNN). The method steps of one example embodiment of the present invention are shown in the boxes drawn by solid lines in FIG. 1A to 1C, while the method steps of further example embodiments of the present invention are shown in the boxes represented by dashed lines.

The first step of the method comprises receiving 100 a data set 60 of real elements, wherein each real element 1; 1a; 2; 2a of the data set of real elements corresponds to a real observation (in the sense defined above). The data set 60 of real elements can be received, e.g., by the monitoring module 20, which can be used for evaluating results of a computer-based machine learning system (see discussions below and FIG. 3, in which the “data set 60 of real elements” is fed to the monitoring module 20). In some cases, the monitoring module 20 can be a vehicle component. As described above, a real element can contain a recorded image (e.g., a digital image) or a portion thereof, captured by a sensor, such as a camera-based system (e.g., a camera-based system of a vehicle). In this case, the data set of real elements can contain a sequence of images (or parts thereof) (e.g., these images can be fed into the monitoring module 20 directly after they are captured while a vehicle is traveling). In some cases, the “data set of real elements” can comprise images recorded by the camera-based system at predefined points in time (e.g., the “data set of real elements” comprises consecutive images separated by a specified time interval). In some cases, the data set of real elements can contain a sequence of images processed by the camera-based system, e.g., in real time during image recording. It is also possible that the “data set of real elements” comprises video captured by the camera-based system (e.g., the video can initially be stored upon capture and then transmitted to the monitoring module 20 at a later point in time). In the example of FIG. 2A and 2B, two real elements 1;2 of the “data set of real elements” are represented as two images recorded at different points in time on which two recorded street scenes can be recognized. Alternatively, two sections of these images 1a; 2a can be used as two real elements of the “data set of real elements” (more on this below). The data set 60 of real elements can comprise one or more, five or more, ten or more, one hundred or more, one thousand or more, or ten thousand or more images.

Next, the present techniques comprise receiving 200 a first result 61; 62 (e.g., by the monitoring module 20 introduced above) calculated by the computer-based machine learning system 70 using the data set of real elements. The computer-based machine learning system 70 can be implemented in a module 30 (in other words, the module 30 can comprise the computer-based machine learning system 70 as shown in FIG. 3), or the module 30 can be the machine learning system 70. In the example of FIG. 3, the data set 60 of real elements (see examples in the previous paragraph for such a data set) fed to the monitoring module 20 is also fed to the module 30. In some cases, module 30 can be a vehicle component. In this connection, the computer-based machine learning system 70 can receive the images recorded by the camera-based system for further processing of these images, e.g., in real time while a vehicle is driving.

In the techniques of the present disclosure, a number of real elements of the data set of real elements can be used as input data to the computer-based machine learning system 70, which generates corresponding output data and an uncertainty value for each real element of the number of real elements. Back to the example with the images as elements: The number of real elements of the data set of real elements can be a number of images (or sections thereof) recorded by the camera-based system at the predefined points in time (e.g., within a specified time interval). For example, one image per “N” recorded images may belong to the number of real elements (e.g., “N” is equal to one or more, two or more, five or more, ten or more, or fifty or more). Furthermore, the uncertainty value of a real element can characterize a confidence measure of the output data generated by the computer-based machine learning system in relation to the real element of the number of real elements (see also definitions above). For example, the uncertainty value of the real element may assume one value (e.g., the value “one”) to reflect the situation if the generated output data are most trustworthy in relation to the real element, and another value (e.g., the value “zero”) if the generated output data are not trustworthy. The uncertainty value of the real element can be between the first and the second value (e.g., between the value “zero” and “one”); other definitions for the uncertainty value of the real element are also possible. Here, the first result 61; 62 (introduced above) can comprise a number of output data 61 and a number of uncertainty values 62 for this number of real elements.

The next step of the method comprises generating 300 a data set 63 of synthetic elements in relation to the data set of real elements. The data set 63 of synthetic elements can be generated, e.g., by the monitoring module 20. As explained in detail above, a “synthetic element” has an artificial origin, which distinguishes it from a “real element.”

In the present techniques, one or more real elements of the data set of real elements can comprise one or more features 10-15 (see definitions above) present in one or more synthetic elements of the data set of synthetic elements generated in relation to the corresponding one or more real elements of the data set of real elements (in other words, starting from the corresponding one or more real elements). In the example of FIG. 2A and 2B, two real images are shown at different points in time, in which six features, namely “vehicles 10, 14,” “pedestrians 11, 13,” and a “cyclist 15” can be seen (e.g., in the correspondingly processed images). The two images 1; 2 can be two images recorded one after the other (or images whose recording times are relatively close to one another), so that they comprise the same features, wherein the corresponding features (e.g., the vehicles 10; 12 in the images 1; 2) are spatially offset from each other. (For example, images 1;2 were recorded with a vehicle-integrated sensor system while a vehicle was moving.) These figures also show examples if parts of these images (regions in dashed circles) can be considered as real elements 1a; 2a with a feature, the “vehicle 10.”

In one example, generating the data set of synthetic elements in relation to the data set of real elements can comprise generating 320 a synthetic element of the data set of synthetic elements using a real element of the data set of real elements. This procedure can be illustrated using the image example as follows: If a real image is an element belonging to the data set of real elements, this image (i.e., a real element in this example) can be used to generate a synthetic image (i.e., a synthetic element in this example). The synthetic image can be generated using one of the methods mentioned above. FIG. 1 comprises six features, namely “vehicles 10, 14,” “pedestrians 11, 13,” and a “cyclist 15.” A synthetic image generated with the aid of image 1 can comprise the same features (so one can say that these images are similar in this sense). Another synthetic image generated using image 2 can also have six features. In another example, a synthetic image can be generated using a portion 1a of image 1. Another synthetic image can be generated using a part 2a of the image 2. In this way, other (e.g., all) synthetic elements of the data set 63 can be generated from synthetic elements (i.e., one synthetic element per corresponding real element).

In the techniques of the present disclosure, the data set of real elements can comprise two or more real elements that are correlated with each other, wherein a correlation between the two or more real elements is determined based on an overlap of the one or more features present on those two or more real elements. Furthermore, generating the data set of synthetic elements in relation to the data set of real elements can comprise generating 340 a synthetic element of the data set of synthetic elements using two or more correlated real elements of the data set of real elements. Such an overlap between a feature present on different elements (e.g., images) can in some cases be defined by a distance metric that characterizes the spatial offset of the same feature at the pixel level on these elements. If, e.g, the distance metric between the feature on two considered elements exceeds a predefined value, this may mean that the overlap falls below a predefined overlap value, so that these two elements are classified as uncorrelated. (If a feature is present on one element while it is absent on another image, this may also mean that the overlap is below the predefined overlap value and these two elements are uncorrelated.) For example, two real elements (i.e., two images 1; 2) represented in the FIG. 2A and 2B are declared as two correlated elements (in the sense defined above), e.g., because two or more (e.g., all six) overlaps for the respective (same) features in the two images exceed the predefined overlap value.

In some cases, if a spatially limited part of the image is considered as an element, a predefined value of the distance metric can be used to select a relevant spatially limited part on different images. In this case, two elements can have the same feature, as illustrated in FIG. 2A and 2B: These images show the feature “vehicle 10” on the respective selected parts 1a; 2a (i.e., elements in this example). In the example of FIG. 2A and 2B, the elements 1a; 2a can be classified as correlated (in the sense defined above), because they contain the feature whose overlap value in the two images exceeds the overlap value. In other cases, the spatially limited parts of the images (as elements) can have more than one feature. In this way, other (e.g., all) synthetic elements of the data set 63 of synthetic elements can be generated (i.e., one synthetic element for two or more corresponding real images). The correlated two or more real elements of the data set of real elements can represent a sequence of two or more images captured at different points in time by a sensor system (e.g., a vehicle-integrated sensor system) (see also the discussions above). In some cases, a generated synthetic element using correlated real elements can emulate a future real element that has not yet been captured.

Within the scope of the present disclosure, it is possible that the “overlap” of one or more features is ascertained by the module 30. In addition, the information in relation to the correlated elements can be forwarded, for example, to the monitoring module 20 (in some cases, “the first result” can contain this information). The monitoring module 20 can, for example, use this information to generate one or more synthetic elements with the aid of correlated real elements (as described above).

The synthetic element data set 63 can contain the synthetic elements generated with the aid of the two techniques mentioned above. The data set 63 of synthetic elements can comprise one or more, five or more, ten or more, one hundred or more, one thousand or more, or ten thousand or more images.

The next step of the method comprises transmitting 400 the data set of synthetic elements. The data set 63 of synthetic elements can be transmitted, for example, from the monitoring module 20, e.g., to an additional module 40. The additional module 40 can comprise the computer-based machine learning system 70, i.e., the same computer-based machine learning system that may belong to the module 30, see FIG. 3. In another case, the data set 63 of synthetic elements can be transmitted, for example, from the monitoring module 20 to the module 30 comprising the computer-based machine learning system 70 (this case is not shown in the figures).

Next, the present techniques comprise receiving 500 a second result 64; 65 calculated by the computer-based machine learning system using the data set of synthetic elements. The second result 64; 65 can be received, for example, by the monitoring module 20, as shown in FIG. 3.

In the techniques of the present disclosure, a number of synthetic elements of the data set of synthetic elements can be used as input data to the computer-based machine learning system 70, which generates corresponding output data and an uncertainty value for each synthetic element of the number of synthetic elements. Furthermore, the uncertainty value of a synthetic element can characterize a confidence measure of the output data generated by the computer-based machine learning system in relation to the synthetic element of the number of synthetic elements. For example, the uncertainty value of the synthetic element may assume a first value (e.g., the value “one”) to reflect the situation if the generated output data are most trustworthy in relation to the synthetic element, and a second value (e.g., the value “zero”) if the generated output data are not trustworthy. The uncertainty value of the synthetic element can be between the first and the second value (e.g., between the value “zero” and “one”); other definitions for the uncertainty value of the synthetic element are also possible. Here, the second result 64; 65 can comprise a number of output data 64 and/or a number of uncertainty values 65 for the number of synthetic elements. The number of synthetic elements can be generated using one or both of the methods described in detail above.

The next step of the method comprises comparing 600 the first result to the second result (e.g., the method step of “comparing” can be performed by the monitoring module 20). Finally, the present techniques comprise determining 700, based on the first result, one or more validity values 66 that characterize a confidence measure of the calculated first result. Alternatively or additionally, the present techniques comprise determining 700, based on comparing the first result to the second result, one or more validity values 66 characterizing a confidence measure of the calculated first result. The method step of “determining” can be performed by the monitoring module 20. For example, a validity bit can have two values: One value can classify the first result as trustworthy (in other words, the validity value can be set to “true”), while the other value can classify the first result as untrustworthy (in other words, the validity value can be set to “false”).

The method step of “determining” the one or more validity values can comprise setting 710 a first validity value to a value (e.g., to “false”) that classifies the first result as untrustworthy if a deviation between an uncertainty value corresponding to a real element observed at a first point in time and an uncertainty value corresponding to a real element observed at a second point in time meets a predetermined criterion, wherein the first point in time is the subsequent point in time in relation to the second point in time. Otherwise, if the deviation does not meet the predetermined criterion, the method step of “determining” the one or more validity values can comprise setting 720 the first validity value to a value (e.g., to “true”) that classifies the first result as trustworthy.

In another case, the method step of “determining” the one or more validity values can comprise setting 730 a first validity value to a value (e.g., to “false”) that classifies the first result as untrustworthy if a deviation between an uncertainty value corresponding to a real element observed at a first point in time and a characteristic uncertainty value meets a predetermined criterion. Furthermore, the data set of real elements can comprise two or more real elements. The characteristic uncertainty value can be a weighted sum of two or more uncertainty values for the two or more real elements (e.g., a mean value of the two or more real elements) observed at respective points in time that are the previous points in time in relation to the first point in time. Otherwise, if the deviation does not meet the predetermined criterion, the method step of “determining” the one or more validity values can comprise setting 740 the first validity value to a value (e.g., to “true”) that classifies the first result as trustworthy.

The predetermined criterion can comprise (for the two variants described above for the method step of “determining”) that the deviation exceeds a predefined threshold value.

In yet another case, the method step of “determining” the one or more validity values can comprise setting 750 a first validity value to a value (e.g., to “false”) that classifies the first result as untrustworthy if a derivative of a function of uncertainty values at a point in time meets a predetermined continuity criterion. The uncertainty value function can describe the uncertainty values as a function of time, which is determined from the number of uncertainty values for the number of real elements observed at different points in time. Otherwise, if the derivative does not meet the predetermined continuity criterion, the method step of “determining” the one or more validity values can comprise setting 760 the first validity value to a value (e.g., to “true”) that classifies the first result as trustworthy. The predetermined continuity criterion can comprise that the derivative exceeds a predefined threshold.

In the techniques of the present disclosure, comparing the first result to the second result can comprise comparing 620 one or more uncertainty values of the number of uncertainty values for one or more real elements from the number of real elements to one or more uncertainty values of the number of uncertainty values for one or more synthetic elements from the number of synthetic elements generated in relation to the corresponding one or more real elements (as described above). Alternatively or additionally, comparing the first result to the second result can comprise comparing 640 output data for one or more real elements of the number of real elements to output data for one or more synthetic elements of the number of synthetic elements generated in relation to the corresponding one or more real elements.

For example, comparing the one or more uncertainty values for the real elements to the corresponding uncertainty values for the synthetic elements can comprise calculating one or more deviations between the one or more uncertainty values for the real elements and the corresponding uncertainty values for the synthetic elements. Alternatively or additionally, comparing output data for the real elements to the corresponding output data for the synthetic elements can comprise ascertaining one or more discrepancies between the output data for the one or more real elements and the corresponding output data for the synthetic elements (e.g., discrepancies in relation to the classification results of features on synthetic and corresponding real elements, as mentioned above).

Furthermore, determining the one or more validity values can comprise setting 770 a second validity value to a value (e.g., to “false”) that classifies the first result as untrustworthy if a deviation of the calculated one or more deviations between the uncertainty values for the real and corresponding synthetic elements meets a predetermined deviation criterion. Otherwise, if the deviation does not meet the predetermined deviation criterion, determining the one or more validity values can comprise setting 780 the second validity value to a value (e.g., to “true”) that classifies the first result as trustworthy. The predetermined deviation criterion can comprise that the deviation exceeds a predefined threshold.

Alternatively or in addition (to the set second validity value), determining the one or more validity values can comprise setting 790 a third validity value to a value (e.g., to “false”) that classifies the first result as untrustworthy if a number of ascertained discrepancies between the output data for the real and corresponding synthetic elements meet a predetermined discrepancy criterion. Otherwise, if the number of ascertained discrepancies does not meet the predetermined discrepancy criterion, determining the one or more validity values can comprise setting 795 the third validity value to a value (e.g., to “true”) that classifies the first result as trustworthy. The predetermined discrepancy criterion can comprise that the number of ascertained discrepancies exceeds a predefined threshold.

The method of the first aspect can further comprise transmitting 800 one or more validity values (e.g., one or more of the first, second, and third validity values defined above). For example, the monitoring module 20 can transmit the one or more validity values (e.g., to a planner 50, as described below).

In the techniques of the present disclosure, the computer-based machine learning system can be designed for image processing (as discussed above), wherein the data set of real elements contains image data. Moreover, the computer-based machine learning module can be an image classifier (e.g., an image classifier that semantically segments image data pixel-by-pixel or region-by-region; see also the above definitions). The image classifier can be designed to receive input data (e.g., real and/or synthetic elements, as described in detail above) in the form of image data and classify them into a plurality of classes (e.g., classify the “features” of these elements into corresponding classes, which can then form the generated output data defined above).

In some examples, the image classification can comprise semantic segmentation of an image (e.g., region-by-region and/or pixel-by-pixel classification of the image). Image classification can be, for example, object classification. For example, the presence of one or more objects (in other words, “features” as defined above) in the image data can be detected (e.g., road users such as pedestrians, cyclists or other vehicles within the framework of autonomous driving or traffic signs or lanes in the context of assisted driving). In this case, the computer-based machine learning systems can be integrated into the vehicle system (e.g., systems for assisted or autonomous driving) in order to provide functionality for the vehicle.

In other examples, the computer-based machine learning system can include a monitoring task (e.g., a manufacturing process and/or quality assurance). For example, the computer-based machine learning system can be designed or used to monitor the operating state and/or environment of an at least partially autonomous robot. In some examples, the at least partially autonomous robot can be an industrial robot. In other examples, the computer-based machine learning system can be designed or used to monitor the operating state and/or environment of a machine (e.g., a machine tool) or a group of machines (e.g., an industrial site). In these examples, the input data can contain state data of the at least partially autonomous robot, the machine or group of machines and/or their environment and the output data can contain information regarding the operating state and/or the environment of the relevant device.

In the present disclosure, a device (e.g., a vehicle, a robot or an industrial plant) can be monitored and/or controlled based on the classification result.

In further examples, the computer-based machine learning system can be designed or used for controlling (or regulating) a device. The device can in turn be one of the devices discussed above (e.g. a vehicle, an at least partially autonomous robot or a machine). In these examples, the input data can contain (as a “real” or “synthetic element”) state data of the device regarding an internal state of the device (e.g., at least some sensor data). Additionally or alternatively, the input data can contain state data regarding the environment of the device (e.g., at least some sensor data). The output data of the computer-based machine learning system can characterize an operating state or other internal condition of the device (e.g., whether or not a fault, an anomaly, or a critical operating condition exists).

A second general aspect of the present disclosure relates to a computer program that is designed to execute the method according to the first general aspect of the present disclosure. The present disclosure also relates to a computer-readable medium (for example, a machine-readable storage medium such as an optical storage medium or read-only memory, for example, FLASH memory) and signals that store or encode the computer program of the present disclosure.

A third general aspect of the present disclosure relates to a monitoring module 20 that is designed to execute the computer-implemented method according to the first general aspect and/or the computer program according to the second general aspect. The monitoring module 20 of the third aspect can be designed to receive the data set 60 from real elements. Furthermore, the monitoring module 20 can be designed to receive the first result 61; 62. Furthermore, the monitoring module 20 of the third aspect can be designed to generate the data set 63 of synthetic elements. In addition, the monitoring module 20 can be designed to transmit the data set 63 of synthetic elements and to receive the second result 64; 65. Furthermore, the monitoring module 20 can be designed to compare the first result to the second result and determine one or more validity values 66 based on the first result and/or the comparison of the first result to the second result. In addition, the monitoring module 20 can be designed to transmit the one or more validity values.

The monitoring module 20 of the third aspect can be integrated into a vehicle computer or designed as an independent in-vehicle component (which, for example, communicates with the vehicle computer). The monitoring module 20 can be designed in the same way for the other devices mentioned above. The monitoring module 20 of the third aspect can communicate externally via appropriate communication protocols.

The monitoring module 20 of the third aspect can comprise one or more processors, controllers, memories, (communication) interfaces, network components, software applications, software architectures, all other software and/or hardware components, parts of the aforementioned, or any combination thereof.

A fourth general aspect of the present disclosure relates to a device (e.g., a vehicle) comprising a monitoring module 20 according to the third aspect. Furthermore, the device comprises a module 30 comprising a computer-based machine learning system 70 (for various embodiments of the computer-based machine learning system, see the discussions above), wherein the module is designed to receive a data set of real elements received from the monitoring module 20 of the third aspect. Furthermore, the module 30 is designed to calculate the first result by the computer-based machine learning system using the data set of real elements and transmit the first result to the monitoring module 20. The device can communicate externally via appropriate communication protocols.

The module 30 can comprise one or more processors, controllers, memories, (communication) interfaces, network components, software applications, software architectures, all other software and/or hardware components, parts of the aforementioned, or any combination thereof.

Furthermore, the device of the fourth aspect can comprise a planner 50 which can be designed to receive one or more validity values from a monitoring module 20 according to the third aspect. Furthermore, the planner 50 can be designed to control operation of a device (e.g., operation of a vehicle or other device discussed above) based on the received validity values.

In the example of an autonomous or semi-autonomous driving vehicle, if the first validity value classifies the first result as untrustworthy (e.g., if the first validity value is set to “false”), a command can be transmitted by the planner 50 (e.g., to a vehicle computer or to a control unit of the vehicle) that triggers a hard maneuver of the vehicle (the hard maneuver can comprise, e.g., emergency braking, stopping the vehicle at a nearby location, turning off the autonomous driving mode, or any combination thereof). On the other hand, if the second and/or the third validity value classifies the first result as untrustworthy (e.g., if the second and/or the third validity value is set to “false”) and the first validity value classifies the first result as trustworthy (e.g., if the first validity value is set to “true”), a command can be transmitted by the planner 50 (e.g., to the vehicle computer or to the control unit of the vehicle) that triggers a gentle maneuver of the vehicle (the gentle maneuver can comprise, e.g., a reduction in the vehicle speed).

The planner 50 can comprise one or more processors, controllers, memories, (communication) interfaces, network components, software applications, software architectures, all other software and/or hardware components, parts of the aforementioned, or any combination thereof.

A fifth general aspect of the present disclosure relates to a distributed system (e.g., in the form of a cloud system) comprising a device according to the fourth aspect and an additional module 40. The additional module 40 can be designed as a device-external component (e.g., a vehicle-external component) (which, for example, communicates with a vehicle computer). The additional module 40 comprises the computer-based machine learning system 70. The computer-based machine learning system of the additional module 40 can be the same computer-based machine learning system that belongs to the module 30 of the device (e.g., both machine learning systems can comprise a model that is described by the same parameters). The additional module 40 can be designed to receive a data set of synthetic elements transmitted from the monitoring module 20 according to the third aspect. Furthermore, the additional module 40 can be designed to generate a second result by the computer-based machine learning system using the data set of synthetic elements and transmit the second result to the monitoring module 20.

The additional module 40 can comprise one or more processors, controllers, memories, (communication) interfaces, network components, software applications, software architectures, all other software and/or hardware components, parts of the aforementioned, or any combination thereof. The additional module 40 can communicate externally via appropriate communication protocols.

1-20. (canceled)

21. A computer-implemented method for evaluating results of a computer-based machine learning system, the method comprising the following steps:
receiving a data set of real elements, wherein each real element of the data set of real elements corresponds to a real observation;
receiving a first result that was calculated by the computer-based machine learning system using the data set of real elements;
generating a data set of synthetic elements in relation to the data set of real elements;
transmitting the data set of synthetic elements;
receiving a second result that was calculated by the computer-based machine learning system using the data set of synthetic elements;
comparing the first result to the second result;
determining, based on: (i) the first result and/or (ii) the comparing of the first result to the second result, one or more validity values characterizing a confidence measure of the calculated first result.

22. The computer-implemented method according to claim 21, wherein one or more real elements of the data set of real elements include one or more features present in one or more synthetic elements of the data set of synthetic elements that were generated in relation to correspondng ones of the one or more real elements of the data set of real elements.

23. The computer-implemented method according to claim 22, wherein the generating of the data set of synthetic elements in relation to the data set of real elements generating each synthetic element of the data set of synthetic elements using a respective real element of the data set of real elements.

24. The computer-implemented method according to claim 21, wherein:
the data set of real elements includes two or more real elements that are correlated with each other, wherein a correlation between the two or more real elements is determined based on an overlap of one or more features present in the two or more real elements, and
the generating of the data set of synthetic elements in relation to the data set of real elements includes generating a synthetic element of the data set of synthetic elements using the two or more correlated real elements of the data set of real elements.

25. The computer-implemented method according to claim 21, wherein:
a number of the real elements of the data set of real elements are used as input data for the computer-based machine learning system, which generates corresponding output data and an uncertainty value for each real element of the number of real elements;
the uncertainty value of a real element characterizes a confidence measure of the output data generated by the computer-based machine learning system in relation to the real element of the number of real elements;
the first result includes a number of output data and a number of uncertainty values for the number of real elements.

26. The computer-implemented method according to claim 25, wherein:
(i) the determining of the one or more validity values includes setting a first validity value to a value that classifies the first result as untrustworthy when a deviation between an uncertainty value corresponding to a real element observed at a first point in time and an uncertainty value corresponding to a real element observed at a second point in time meets a predetermined criterion, wherein the first point in time is the subsequent time in relation to the second point in time, and
when the deviation does not meet the predetermined criterion, setting the first validity value to a value that classifies the first result as trustworthy; or
(ii) the determining the one or more validity values includes setting a first validity value to a value that classifies the first result as untrustworthy when a deviation between an uncertainty value corresponding to a real element observed at a first point in time, and a characteristic uncertainty value meets a predetermined criterion, the data set of real elements includes two or more real elements, and characteristic uncertainty value is a weighted sum of the two or more uncertainty values for the two or more real elements observed at particular points in time that are the previous points in time in relation to the first point in time,
when the deviation does not meet the predetermined criterion, setting the first validity value to a value that classifies the first result as trustworthy.

27. The computer-implemented method according to claim 25, wherein:
the determining of the one or more validity values includes setting a first validity value to a value that classifies the first result as untrustworthy when a derivative of a function of uncertainty values at a point in time meets a predetermined continuity criterion,
the function of uncertainty values describes the uncertainty values as a function of time, which is determined from the number of uncertainty values for the number of real elements that were observed at different points in time,
when the derivative does not meet the predetermined continuity criterion, setting the first validity value to a value that classifies the first result as trustworthy.

28. The computer-implemented method according to claim 25, wherein:
a number of synthetic elements of the data set of synthetic elements are used as input data for the computer-based machine learning system. which generates corresponding output data and an uncertainty value for each synthetic element of the number of synthetic elements,
the uncertainty value of a synthetic element characterizes a confidence measure of the output data generated by the computer-based machine learning system in relation to the synthetic element of the number of synthetic elements,
the second result includes a number of output data and/or a number of uncertainty values for the number of synthetic elements.

29. The computer-implemented method according to claim 28, wherein the comparing the first result to the second result includes:
(i) comparing one or more uncertainty values of the number of uncertainty values for one or more real elements from the number of real elements to one or more uncertainty values of the number of uncertainty values for one or more synthetic elements from the number of synthetic elements generated in relation to the corresponding one or more real elements; and/or
(ii) comparing output data for one or more real elements from the number of real elements to output data for one or more synthetic elements from the number of synthetic elements generated in relation to the corresponding one or more real elements.

30. The computer-implemented method according to claim 29, wherein the comparing of the one or more uncertainty values for the real elements to the corresponding uncertainty values for the synthetic elements includes calculating one or more deviations between the one or more uncertainty values for the real elements and the corresponding uncertainty values for the synthetic elements.

31. The computer-implemented method according to claim 30, wherein:
the determining of the one or more validity values includes setting a second validity value to a value that classifies the first result as untrustworthy when a deviation of the calculated one or more deviations between the uncertainty values for the real and corresponding synthetic elements meets a predetermined deviation criterion, and
when the deviation does not meet the predetermined deviation criterion, setting the second validity value to a value that classifies the first result as trustworthy.

32. The computer-implemented method according to claim 29, wherein the comparing of the output data for the real elements to the corresponding output data for the synthetic elements includes ascertaining one or more discrepancies between the output data for the one or more real elements and the corresponding output data for the synthetic elements.

33. The computer-implemented method according to claim 32, wherein:
the determining of the one or more validity values includes setting a third validity value to a value that classifies the first result as untrustworthy when a number of ascertained discrepancies between the output data for the real and corresponding synthetic elements meet a predetermined discrepancy criterion, and
when the number of ascertained discrepancies does not meet the predetermined discrepancy criterion, setting the third validity value to a value that classifies the first result as trustworthy.

34. The computer-implemented method according to claim 21, further comprising transmitting one or more of the validity values.

35. The computer-implemented method according to claim 21, wherein the computer-based machine learning system is configured for image processing and wherein the data set of real elements contains image data.

36. The computer-implemented method according to claim 35, wherein the computer-based machine learning module is an image classifier.

37. A non-transitory computer-readable medium on which is stored a computer program for evaluating results of a computer-based machine learning system, the computer program, when executed by a computer, causing the computer to perform the following steps:
receiving a data set of real elements, wherein each real element of the data set of real elements corresponds to a real observation;
receiving a first result that was calculated by the computer-based machine learning system using the data set of real elements;
generating a data set of synthetic elements in relation to the data set of real elements;
transmitting the data set of synthetic elements;
receiving a second result that was calculated by the computer-based machine learning system using the data set of synthetic elements;
comparing the first result to the second result;
determining, based on: (i) the first result and/or (ii) the comparing of the first result to the second result, one or more validity values characterizing a confidence measure of the calculated first result.

38. A monitoring module configured to evaluate results of a computer-based machine learning system, the monitoring module configured to:
receive a data set of real elements, wherein each real element of the data set of real elements corresponds to a real observation;
receive a first result that was calculated by the computer-based machine learning system using the data set of real elements;
generate a data set of synthetic elements in relation to the data set of real elements;
transmit the data set of synthetic elements;
receive a second result that was calculated by the computer-based machine learning system using the data set of synthetic elements;
compare the first result to the second result;
determine, based on: (i) the first result and/or (ii) the comparing of the first result to the second result, one or more validity values characterizing a confidence measure of the calculated first result.

39. A device comprising:
a monitoring module configured to evaluate results of a computer-based machine learning system, the monitoring module configured to:
receive a data set of real elements, wherein each real element of the data set of real elements corresponds to a real observation,
receive a first result that was calculated by the computer-based machine learning system using the data set of real elements,
generate a data set of synthetic elements in relation to the data set of real elements,
transmit the data set of synthetic elements,
receive a second result that was calculated by the computer-based machine learning system using the data set of synthetic elements,
compare the first result to the second result,
determine, based on: (i) the first result and/or (ii) the comparing of the first result to the second result, one or more validity values characterizing a confidence measure of the calculated first result; and
a module including the computer-based machine learning system, wherein the module is configured to to:
receive the data set of real elements received from the monitoring module,
calculate the first result by the computer-based machine learning system using the data set of real elements, and
transmit the first result to the monitoring module.

40. A distributed system, comprising:
a device including:
a monitoring module configured to evaluate results of a computer-based machine learning system, the monitoring module configured to:
receive a data set of real elements, wherein each real element of the data set of real elements corresponds to a real observation,
receive a first result that was calculated by the computer-based machine learning system using the data set of real elements,
generate a data set of synthetic elements in relation to the data set of real elements,
transmit the data set of synthetic elements,
receive a second result that was calculated by the computer-based machine learning system using the data set of synthetic elements, compare the first result to the second result,
determine, based on: (i) the first result and/or (ii) the comparing of the first result to the second result, one or more validity values characterizing a confidence measure of the calculated first result; and
a module including the computer-based machine learning system, wherein the module is configured to to:
receive the data set of real elements received from the monitoring module,
calculate the first result by the computer-based machine learning system using the data set of real elements, and
transmit the first result to the monitoring module; and
an additional module including the computer-based machine learning system, wherein the additional module is configured to:
receive a data set of synthetic elements transmitted from the monitoring module;
generate a second result by the computer-based machine learning system using the data set of synthetic elements; and
transmit the second result to the monitoring module.
